(19) United States
(12) Patent Application Publication
(10) Pub. No.: US 2012/0283849 A1
(43) Pub. Date: Nov. 8, 2012

(54) SENSOR SYSTEM HAVING TIME LAG COMPENSATION

(76) Inventor: Ridwan KUREEMUN, Luton (GB)

(21) Appl. No.: 13/102,640

(22) Filed: May 6, 2011

(51) Int. Cl. G05B 13/04; G01K 15/00; G06F 19/00

(52) U.S. Cl. 700/30; 702/104; 702/99

(57) ABSTRACT

A sensor system for use with a machine is disclosed. The sensor system may have a sensor associated with the machine and configured to generate a signal indicative of an actual value for a parameter of the machine, and a controller in communication with the sensor. The controller may be configured to model behavior of the machine under particular conditions and responsively generate a first predicted value for the parameter, determine a time lag coefficient for the sensor based on the signal, model behavior of the sensor based on the time lag coefficient and the first predicted value, and responsively generate a second predicted value for the parameter. The controller may also be configured to determine an error value based on the actual value and the second predicted value, and determine a compensated value for the parameter based on the first predicted value and the error value.

### TECHNICAL FIELD

The present disclosure is directed to a sensor system and, more particularly, to a sensor system having time lag compensation.

### BACKGROUND

Many industrial machines are equipped with sensors to facilitate control thereof. For example, engines such as diesel, gasoline, and gaseous-fueled internal combustion engines that are used to power generator sets, pumps, drills, and mobile machines can be equipped with sensors that generate signals indicative of operational parameters of an associated medium. These sensors can include temperature sensors, pressure sensors, flow rate sensors, viscosity sensors, humidity sensors, constituent sensors, etc., and can be associated with gases or liquids that circulate throughout the engines and associated systems. The signals generated by these sensors are used as control terms that affect the way the engines are operated. A quality of an engine's performance can be affected by the measurement accuracy of the sensors.

At least two different types of errors can be associated with the sensors described above. Specifically, each sensor may have a relatively static error associated with an offset between a true value of the parameter and a measured value, and a dynamic error associated with a phase delay between a time when the parameter was first measured by the sensor and a time when the corresponding signal generated by the sensor is received and interpreted by an associated controller. During this delay, the parameter can significantly change such that the value of the signal received by the controller no longer matches the true value of the medium.

One way to help improve sensor accuracy is disclosed in U.S. Pat. No. 5,080,496 of Keim et al. that issued on Jan. 14, 1992 (the '496 patent). Specifically, the '496 patent discloses a temperature prediction control system that includes a temperature sensor, a rotor model, a sensor model, and a proportional integral control. The rotor model receives input regarding operation of a rotor and, based on this input and known information regarding the rotor, estimates a simulated first temperature of air passing through the rotor. The sensor model receives the simulated first temperature of the air and utilizes known information about the temperature sensor to estimate a second temperature of the air that accounts for a thermal lag of the sensor. The second temperature can be used for control purposes, and the proportional integral control may adjust the system model to account for differences between an actual measured temperature and the second temperature.

Although the temperature prediction control system of the '496 patent may improve machine control based on monitored temperatures, the temperature prediction control system may be less than optimal. In particular, the sensor model disclosed in the '496 patent utilizes a predetermined graph for providing a time constant associated with the thermal lag, which may only be accurate during particular known operating conditions under which the graph was originally created. When operating outside of these known conditions, the accuracy of the sensor model may degrade.

The disclosed sensor system is directed to overcoming one or more of the problems set forth above and/or other problems of the prior art.

### SUMMARY

One aspect of the present disclosure is directed to a sensor system for use with a machine. The sensor system may include a sensor associated with the machine and configured to generate a signal indicative of an actual value for a parameter of the machine, and a controller in communication with the sensor. The controller may be configured to model behavior of the machine under particular conditions and responsively generate a first predicted value for the parameter, determine a time lag coefficient for the sensor based on the signal, model behavior of the sensor based on the time lag coefficient and the first predicted value, and responsively generate a second predicted value for the parameter. The controller may also be configured to determine an error value based on the actual value and the second predicted value, and determine a compensated value for the parameter based on the first predicted value and the error value.

Another aspect of the present disclosure is directed to a method of compensating a machine sensor. The method may include receiving a signal from the machine sensor indicative of an actual value for a machine parameter, modeling behavior of a machine under particular conditions and responsively generating a first predicted value for the machine parameter, and determining a time lag coefficient for the machine sensor based on the signal. The method may also include modeling behavior of the machine sensor based on the time lag coefficient and the first predicted value, and responsively generating a second predicted value for the machine parameter. The method may further include determining an error value based on the actual value and the second predicted value, and determining a compensated value for the machine parameter based on the first predicted value and the error value.

### BRIEF DESCRIPTION OF THE DRAWINGS

FIG. 1 is a diagrammatic illustration of an exemplary disclosed sensor system;

FIG. 2 is a process chart depicting an exemplary disclosed method performed by the sensor system of FIG. 1; and

FIG. 3 is a graph illustrating operation of the disclosed sensor system during performance of the method of FIG. 2.

### DETAILED DESCRIPTION

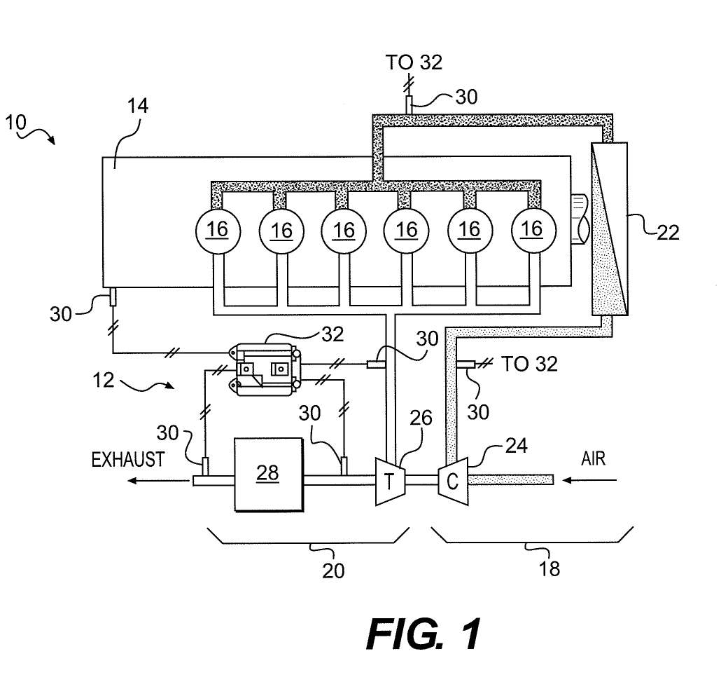

FIG. 1 illustrates a machine 10 equipped with an exemplary sensor system 12. For the purposes of this disclosure, machine 10 is depicted and described as a diesel-fueled, internal-combustion engine. However, it is contemplated that machine 10 may embody any other type of machine, such as, for example, a gasoline or a gaseous fuel-powered engine, a fuel cell, a pump, a drill, a mobile vehicle, or another type of machine benefiting from monitoring of a performance parameter by sensor system 12.

Machine 10, as an internal combustion engine, may include an engine block 14 at least partially defining a plurality of cylinders 16, and multiple separate subsystems that facilitate gaseous and/or fluid movement through and around cylinders 16. For example, machine 10 may include an air induction system 18 and an exhaust system 20. Air induction system 18 may be configured to direct air or an air and fuel mixture into cylinders 16 for subsequent combustion. Exhaust system 20 may treat and exhaust byproducts of combustion to the atmosphere. It is contemplated that machine 10 may be equipped with additional gas- and/or liquid-handling subsystems, if desired, such as fuel systems, coolant systems, lubrication systems, hydraulic tool systems, hydrostatic transmission systems, and other systems known in the art.

Air induction system 18 may include multiple components that cooperate to condition and introduce compressed air into cylinders 16. For example, air induction system 18 may include an air cooler 22 located downstream of one or more compressors 24. Compressors 24 may be connected to pressurize inlet air directed through cooler 22. It is contemplated that air induction system 18 may include different or additional components than described above such as, for example, a throttle valve, variable valve actuators associated with each cylinder 16, filtering components, compressor bypass components, and other known components, if desired. It is further contemplated that compressor 24 and/or cooler 22 may be omitted, if a naturally aspirated engine is desired.

Exhaust system 20 may include multiple components that condition and direct exhaust from cylinders 16 to the atmosphere. For example, exhaust system 20 may include one or more turbines 26 driven by exhaust flowing from cylinders 16 to drive compressor 24, and an exhaust treatment device 28 fluidly connected downstream of turbine 26. It is contemplated that exhaust system 20 may include different or additional components than described above such as, for example, bypass components, an exhaust compression or restriction brake, an attenuation device, additional exhaust treatment devices, Exhaust Gas Recirculation (EGR) components, and other known components, if desired.

The components and subsystems of machine 10 may perform optimally when performance parameters of the gases and/or fluids passing therethrough are maintained within particular ranges. For example, the pressurized air from compressor 24 should be chilled to below a particular threshold within cooler 22 in order for optimum combustion to occur within cylinders 16. In another example, compressor 24 and/or turbine 26 may need to be maintained at or below particular temperatures in order for longevity of these components to be ensured. In yet another example, exhaust treatment device 28 may need to be maintained within a particular range of temperatures in order for a desired amount of constituent reduction to occur therein. As long as the temperatures of these components and/or subsystems are known with a relatively high degree of accuracy, control of the temperatures and operation of the components and subsystems may be regulated in a desired manner. Accurate knowledge of other parameters, for example humidity, flow rate, constituent concentration, etc. may also be important to the functionality of the components and subsystems of machine 10.

Sensor system 12 may include components that cooperate to monitor the performance parameters (e.g., temperature, humidity, flow rate, constituent concentration, speed, etc.) of machine 10. Specifically, sensor system 12 may include at least one sensor 30, and a controller 32 in communication with each sensor 30. Based on input from sensor(s) 30, controller 32 may determine required adjustments to the operation of machine 10 to bring the performance parameters inline with desired values.

Sensor(s) 30 may be provided at any convenient location within machine 10 to monitor various performance parameters of machine 10 and generate corresponding signals indicative of actual values of the parameters. In one example, sensors 30 may embody temperature sensors (e.g., thermocouples) located upstream and/or downstream of cooler 22 to monitor a temperature of inlet air passing from compressor 24 into cooler 22 and/or from cooler 22 into cylinders 16. In another example, sensors 30 may be exhaust constituent, humidity, flow rate, and/or temperature sensors located within exhaust system 20, for instance upstream and/or downstream of turbine 26 and exhaust treatment device 28. The signals generated by sensors 30 may be utilized by controller 32 to determine a need to change a coolant flow rate passing through cooler 22, a fuel injection timing and/or amount of fuel that should be injected into cylinders 16, an amount of reductant that should be injected into the exhaust passing through treatment device 28, a reducing capacity of treatment device 28, and/or other similar changes to the operation of machine 10. Controller 32 may then selectively implement these changes based on the signals from sensor(s) 30.

Controller 32 may embody a single or multiple microprocessors, field programmable gate arrays (FPGAs), digital signal processors (DSPs), etc., that include a means for controlling an operation of machine 10 in response to signals received from the various sensors 30. Numerous commercially available microprocessors can be configured to perform the functions of controller 32. It should be appreciated that controller 32 could readily embody a microprocessor separate from that controlling other non-exhaust related power system functions, or that controller 32 could be integral with a general machine microprocessor and be capable of controlling numerous power system functions and modes of operation. If separate from the general machine microprocessor, controller 32 may communicate with the general machine microprocessor via datalinks or other methods. Various other known circuits may be associated with controller 32, including power supply circuitry, signal-conditioning circuitry, actuator driver circuitry (i.e., circuitry powering solenoids, motors, or piezo actuators), communication circuitry, and other appropriate circuitry.

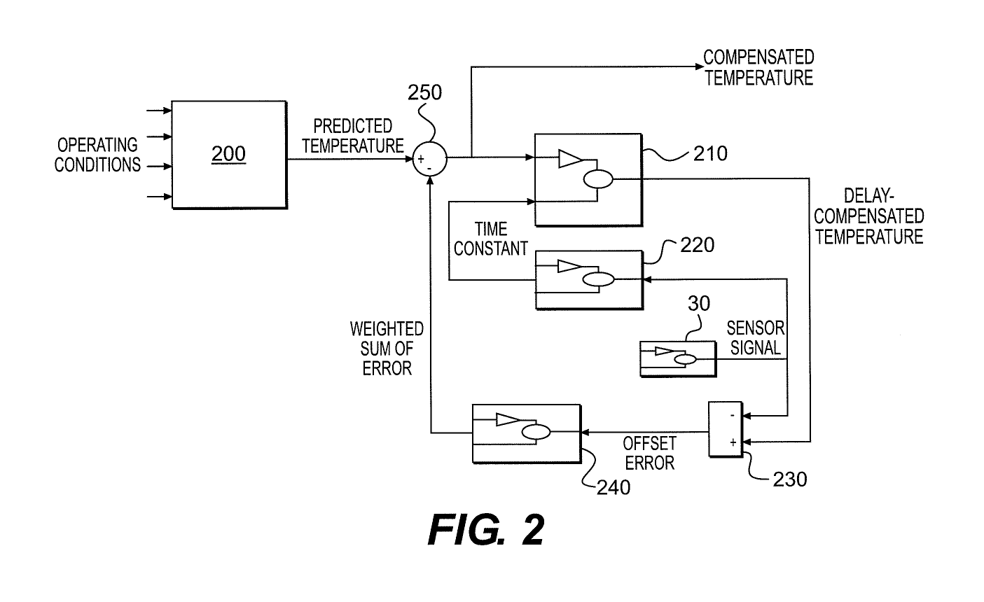

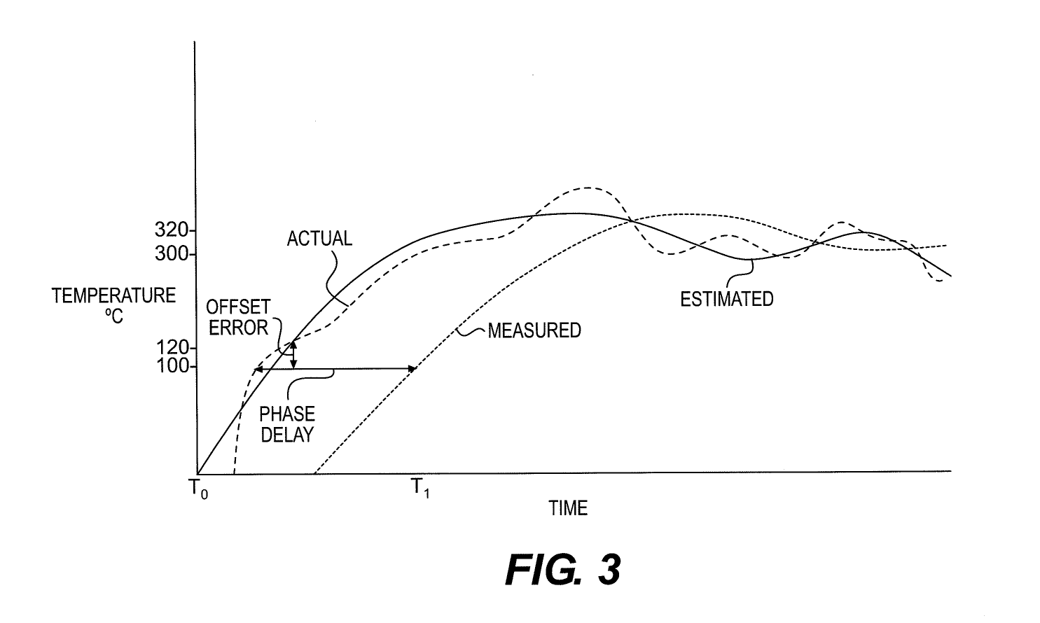

As illustrated in the process chart of FIG. 2, controller 32 may be configured to compensate sensor 30 for both a static error and a dynamic error such that an accuracy of sensor 30 may be enhanced (i.e., such that an instantaneous signal from sensor 30 that has been received by controller 32 is substantially identical to an actual value of the parameter monitored by sensor 30 at the time of signal receipt). FIG. 3 illustrates a particular example of controller compensation. FIGS. 2 and 3 will be discussed in more detail in the following section to further illustrate the disclosed concepts.

### INDUSTRIAL APPLICABILITY

The sensor system of the present disclosure may be applicable to any machine where accurate measurements of performance parameters are important. The disclosed sensor system may be particularly applicable to internal combustion engines, where accurate knowledge of highly transient parameter values, for example air and/or exhaust temperature values, are important to optimal control of the engines. Measurements made by the system's sensors may be compensated by the disclosed controller to account for both dynamic and static errors of the sensor system, thereby improving accuracy of the system. Operation of sensor system 12 will now be described in detail.

As shown in FIG. 2, during operation of machine 10 and sensor system 12, controller 32 may be configured to use a machine behavior model 200 to predict an instantaneous value for a parameter being monitored by a particular sensor 30. In particular, controller 32 may receive as input known operating conditions of machine 10, for example a current operating speed, a fuel injection timing and/or amount, a peak cylinder pressure, a boost pressure, an environmental temperature, and/or other similar operating conditions; and use machine behavior model 200 to predict a resulting parameter value (e.g., to predict a resulting exhaust temperature) that is also currently being monitored by an onboard sensor 30 (e.g., the sensor 30 located at the position downstream of turbine 26 and upstream of exhaust treatment device 28). The operating conditions may be received by controller 32 in any manner from any component of machine 10. Machine behavior model 200 that is used by controller 32 to predict the parameter value may include one or more equations, algorithms, maps, and/or subroutines that function to predict the physical behavior of machine 10 based on the received operating conditions. Each of the equations, algorithms, maps, and/or subroutines may be developed during manufacture of machine 10 and periodically updated and/or uniquely tuned based on actual operating conditions and corresponding performance of individual machines 10.

In the example of FIG. 3, three curves are shown, including an estimated temperature curve, an actual temperature curve, and a measured temperature curve. The estimated temperature curve corresponds with the exhaust temperatures predicted by controller 32 through the use of behavior model 200. The actual temperature curve corresponds with the true temperature of the exhaust. The measured temperature curve corresponds with the value of the signal from sensor 30, as it is received and/or interpreted by controller 32. In the specific example of FIG. 3, the estimated temperature curve shows a predicted exhaust temperature at a time T1 of about 320° C. At this same time, the true temperature of the exhaust from machine 10 at the location of sensor 30 is about 300° C. and, due to dynamic and static errors in sensor system 12, sensor 30 delivers a signal to controller 30 at time T1 indicative of an exhaust temperature of about 100° C.

Referring back to FIG. 2, controller 32 may also be configured to use a sensor behavior model 210 to determine a phase delay associated with sensor 30, and to compensate the predicted parameter for the phase delay (i.e., to phase shift by the delay amount the value of the parameter predicted by machine behavior model 200). The phase delay may correspond with a lag between a time when sensor 30 first detects the performance parameter and a time when a signal indicative of the detected parameter is received and/or interpreted by controller 32. This lag may be represented in the graph of FIG. 3 as the horizontal distance between the actual temperature curve and the measured temperature curve. It should be noted that this time lag may be different for each sensor 30, different for each type of sensor 30, different for each sensor location on machine 10, and/or different over time. After determining the time lag for a specific sensor 30 at a particular location within machine 10 and at a particular point in time, the value of the parameter (e.g., the temperature) predicted by behavior model 200 may be phase shifted by a corresponding amount. In the example of FIG. 3, controller 32 at time T1 utilizes sensor behavior model 210 to phase shift the estimated temperature from machine model behavior 200 from about 320° C. on the estimated temperature curve to about 120° C. (i.e., leftward in FIG. 3).

Similar to machine behavior model 200, sensor behavior model 210 may include one or more equations, algorithms, maps, and/or subroutines that function to predict the physical response of sensor 30 (and/or sensor system 12) based on the signal generated by sensor 30. Each of the equations, algorithms, maps, and/or subroutines may be developed during manufacture of machine 10 and periodically updated and/or uniquely tuned based on actual operating conditions and corresponding performance of individual machines 10. In the disclosed embodiment, the behavior of sensor 30 that is modeled by controller 32 may be a first order behavior (i.e., sensor behavior model 210 may be configured to model a first order response of sensor 30). Higher order behaviors may alternatively be modeled to improve accuracy in determining the phase delay of sensor 30. However, the amount of improvement gained by the higher order behavior modeling, in certain embodiments, may not warrant the corresponding increase in computing complexity.

The first order response of sensor behavior may be determined for a particular sensor 30 through the use of a time constant. In the disclosed embodiment, the time constant may be different for each sensor 30 and variable over time (i.e., the time constant may be dynamic). Controller 32 may continuously determine the dynamic time constant for a particular sensor 30 based on analysis of the signal from that sensor 30. The analysis may include use of an identification model 220. In the disclosed embodiment, identification model 220 may include a recursive least squares algorithm, although any type of identification model known in the art may be utilized.

Use of a conventional recursive least squares algorithm to determine the dynamic time constant for a particular sensor 30 may be less than optimal under some conditions. In particular, a conventional recursive least squares algorithm may apply the same weighting to every input and output even though the input and output may change over time. In reality, newer inputs and outputs will most likely affect the current output more than older inputs and outputs. Hence, in order to improve accuracy, variable weighting should be utilized to determine the dynamic time constant. Accordingly, the disclosed embodiment implements an exponential-forgetting method, wherein a forgetting factor α is used to decrease the weighting of data from previous cycles of the algorithm. In particular, an input Uᵢ and an output Yᵢ are weighted by α^{k-i}. The method is explained below.

$$Let G ( z ) = \frac{B ( {z}^{- 1} )}{A ( {z}^{- 1} )} = \frac{{b}_{1} {z}^{- 1}}{1 + {a}_{1} {z}^{- 1}}$$

Then the estimated output ŷₖ at time step k is given by ŷₖ=−â₁yₖ₋₁+\hat{b}₁uₖ₋₁, where â₁ and \hat{b}₁ are current estimation of process parameters.

In vector form,

ŷₖ=Ωₖ₋₁^{T}Ψₖ

Ωₖ₋₁^{T}=[â₁,\hat{b}₁]^{T}

Ψₖ=[−yₖ₋₁,uₖ₋₁]^{T}

The parameter estimation vector is calculated as follows:

$${Ω}_{k} = {Ω}_{k - 1} + \frac{{C}_{k - 1} \cdot {Ψ}_{k}}{α + {Ψ}_{k}^{T} \cdot {C}_{k - 1} \cdot {Ψ}_{k}} \cdot ( {y}_{k} - {Ω}_{k - 1}^{T} {Ψ}_{k} ) ,$$

where the dynamic time constant Cₖ is defined as:

$${C}_{k} = \frac{1}{α} ( {C}_{k - 1} - \frac{{C}_{k - 1} \cdot {Ψ}_{k} \cdot {Ψ}_{k}^{T} \cdot {C}_{k - 1}}{α + {Ψ}_{k}^{T} \cdot {C}_{k - 1} \cdot {Ψ}_{k}} )$$

Returning to FIG. 2, once the parameter value predicted by machine behavior model 200 has been compensated for the phase delay of sensor 30, which was determined through the use of sensor behavior model 210 (i.e., once the predicted value has been phase shifted), controller 32 may compare the predicted and phase shifted value to a value of the actual signal from sensor 30, and determine an offset error at a summation block 230 based on the comparison (i.e., controller 32 may determine a difference between the two values). The offset error may be represented in FIG. 3 by a vertical distance between the phase shifted temperature on the estimated temperature curve and the signal value on the measured temperature curve at time T1. This offset error may then be passed through a discrete proportional integral (PI) module 240 of controller 32, where a weighted sum of the error over time is determined. This weighted sum of the error may then be applied at a summation block 250 to the parameter value predicted by behavior model 200, thereby producing a final parameter value that has been compensated for both dynamic (i.e., phase delay) and static (i.e., offset) errors of sensor 30. PI module 240 may be mainly dominated by proportional action to enable a fast correction of the error. As steady error may be of relatively low importance for the estimated temperature values, a small integral gain may be used by PI module 240.

In the example of FIG. 3, the error determined at summation block 230 (referring to FIG. 2) is about equal to 20° C., and the weighted sum of the error is calculated to be about 20° C. The weighted sum of the error is then applied at summation block 250 to the predicted parameter value of about 320° C. that was determined through use of machine behavior model 200 to determine a final compensated value of about 300° C., which is a much more accurate value when compared to the original sensor signal value of about 100° C. received by controller 32 at time T1.

Because the disclosed sensor system may determine and utilize a dynamic time constant each time the phase delay of sensor 30 is calculated, the physical response of sensor 30 may be accurately modeled. By accurately modeling the physical response of sensor 30, the performance value monitored by sensor 30 may be more accurately compensated for both dynamic and static errors of the disclosed sensor system, thereby enhancing control of the associated machine.

It will be apparent to those skilled in the art that various modifications and variations can be made to the sensor system of the present disclosure. Other embodiments will be apparent to those skilled in the art from consideration of the specification and practice of the sensor system disclosed herein. It is intended that the specification and examples be considered as exemplary only, with a true scope being indicated by the following claims and their equivalents.

What is claimed is:

1. A sensor system for use with a machine, comprising:
a sensor associated with the machine and configured to generate a signal indicative of an actual value for a parameter of the machine; and
a controller in communication with the sensor and configured to:
model behavior of the machine under particular conditions and responsively generate a first predicted value for the parameter;
determine a time lag coefficient for the sensor based on the signal;
model behavior of the sensor based on the time lag coefficient and the first predicted value, and responsively generate a second predicted value for the parameter;
determine an error value based on the actual value and the second predicted value; and
determine a compensated value for the parameter based on the first predicted value and the error value.

2. The sensor system of claim 1, wherein the time lag coefficient is determined via a recursive least squares algorithm.

3. The sensor system of claim 1, wherein the controller is configured to model behavior of the sensor by modeling a first order behavior of the sensor.

4. The sensor system of claim 1, wherein the controller is configured to receive input associated with the particular conditions.

5. The sensor system of claim 1, wherein the parameter is associated with a medium passing through the machine.

6. The sensor system of claim 5, wherein the medium is air or exhaust and the parameter is a temperature.

7. The sensor system of claim 1, wherein:
the controller is proportional integral controller and configured to determine a weighted sum of the error value over time; and
the compensated value for the parameter is determined based on the first predicted value and the weighted sum of the error value.

8. The sensor system of claim 7, wherein the behavior of the sensor is modeled based further on the weighted sum of the error value to predict the second value for the parameter.

9. The sensor system of claim 1, wherein behavior of the sensor includes a time lag from a time of parameter monitoring to a time of signal delivery to the controller.

10. The sensor system of claim 1, wherein:
the error value is a difference between the actual and second predicted values; and
the compensated value is about equal to a sum of the first predicted value and the error value.

11. The sensor system of claim 1, wherein the controller is further configured to adjust operation of the machine based on the compensated value.

12. A sensor system, comprising:
a thermocouple configured to sense a gas temperature of an engine and generate a signal indicative of an actual value for the gas temperature; and
a proportional integral controller in communication with the thermocouple and configured to:
model behavior of the engine under particular conditions and responsively generate a first predicted value for the gas temperature;
determine a time lag coefficient for the thermocouple based on the signal via a recursive least squares algorithm;
model a first order behavior of the thermocouple based on the time lag coefficient, the first predicted value, and a weighted sum of an error value, and responsively generate a second predicted value for the gas temperature;
determine the error value based on a difference between the actual value and the second predicted value;
determine a compensated value for the gas temperature based on the first predicted value and the error value; and
adjust operation of the engine based on the compensated value.

13. A method of compensating a machine sensor, the method comprising:
receiving a signal from the machine sensor indicative of an actual value for a machine parameter;
modeling behavior of a machine under particular conditions and responsively generating a first predicted value for the machine parameter;
determining a time lag coefficient for the machine sensor based on the signal;
modeling behavior of the machine sensor based on the time lag coefficient and the first predicted value, and responsively generating a second predicted value for the machine parameter;
determining an error value based on the actual value and the second predicted value; and
determining a compensated value for the machine parameter based on the first predicted value and the error value.

14. The method of claim 13, wherein the time lag coefficient is determined via a recursive least squares algorithm.

15. The method of claim 13, wherein modeling behavior of the machine sensor includes modeling a first order behavior.

16. The method of claim 13, further including receiving input associated with the particular conditions.

17. The method of claim 13, wherein the parameter is a temperature associated with air or exhaust passing through the machine.

18. The method of claim 13, wherein the behavior of the sensor includes a time lag from a time of parameter detection to a time of signal delivery to a controller.

19. The method of claim 13, further including determining a weighted sum of the error value over time, wherein:
determining the compensated value for the machine parameter includes determining the compensated value for the machine parameter based on the first predicted value and the weighted sum; and
modeling behavior of the machine sensor includes modeling behavior of the machine sensor based further on the weighted sum.

20. The method of claim 13, wherein:
the error value is a difference between the actual and second predicted values; and
the compensated value is about equal to a sum of the first predicted value and the error value.
